(19) United States
(12) Patent Application Publication
(10) Pub. No.: US 2011/0158476 A1
(43) Pub. Date: Jun. 30, 2011

(54) ROBOT AND METHOD FOR RECOGNIZING HUMAN FACES AND GESTURES THEREOF

(75) Inventors: Chin-Shyurng Fahn, Taipei City (TW); Keng-Yu Chu, Taipei (TW); Chih-Hsin Wang, Taipei (TW)

(73) Assignee: National Taiwan University of Science and Technology, Taipei (TW)

(21) Appl. No.: 12/829,370

(22) Filed: Jul. 1, 2010

(30) Foreign Application Priority Data
Dec. 24, 2009 (TW) 98144810

(51) Int. Cl. G06K 9/46; G06K 9/00

(52) U.S. Cl. 382/103; 382/190; 901/50

(57) ABSTRACT

A robot and a method for recognizing human faces and gestures are provided, and the method is applicable to a robot. In the method, a plurality of face regions within an image sequence captured by the robot are processed by a first classifier, so as to locate a current position of a specific user from the face regions. Changes of the current position of the specific user are tracked to move the robot accordingly. While the current position of the specific user is tracked, a gesture feature of the specific user is extracted by analyzing the image sequence. An operating instruction corresponding to the gesture feature is recognized by processing the gesture feature through a second classifier, and the robot is controlled to execute a relevant action according to the operating instruction.

### CROSS-REFERENCE TO RELATED APPLICATION

This application claims the priority benefit of Taiwan application serial no. 98144810, filed on Dec. 24, 2009. The entirety of the above-mentioned patent application is hereby incorporated by reference herein and made a part of specification.

### BACKGROUND OF INVENTION

1. Field of Invention

The invention relates to an interactive robot. More particularly, the invention relates to a robot and a method for recognizing and tracking human faces and gestures thereof.

2. Description of Related Art

The conventional approach for man-machine interaction relies on a device including a keyboard, a mouse, or a touchpad for user to input instruction. The device processes the instructions input by user and produces corresponding responses. With the advancement of technology, voice and gesture recognitions have come to play a more significant role in this field. Some interactive systems can even receive and process instructions input through the voice or body movement of user.

As gesture recognition technology requires specific sensing devices, users must wear sensor gloves or the like to provide commands. However, the high cost of such devices compromises their availability to the public, and the sensor glove can also be rather inconvenient for the users to operate.

Furthermore, when the gesture recognition technology based on image analysis is applied, fixed video cameras are often used to take images of hand gestures, and the gesture features are then extracted by analyzing the captured images. Nevertheless, since the position of the video camera is fixed, users' movement are limited. Furthermore, users must adjust the angles of the video cameras manually to ensure the capture of their hand movements by the video cameras.

Since most gesture recognition technologies are directed to the recognition of static hand poses, only a limited amount of hand gestures can be identified. In other words, such technologies can only result in limited responses in regards to man-machine interaction. Moreover, since the input instructions do not instinctively correspond to the static hand poses, users must spend more time to memorize specific hand gestures that correspond to the desired operating instructions.

### SUMMARY OF INVENTION

The invention is directed to a method for recognizing human faces and gestures. The method can be applied to identify and track a specific user, so as to correspondingly operate a robot based on the gestures of the specific user.

The invention is further directed to a robot capable of recognizing the identity and the gestures of its owner, and thus instantly interacting with the owner accordingly.

The invention provides a method for recognizing human faces and gestures. The method is suitable for recognizing movement of a specific user to control a robot accordingly. In this method, a plurality of face regions within an image sequence captured by the robot is processed by a first classifier, so as to locate a current position of the specific user according to the face regions. Change of the current position of the specific user is tracked so as to move the robot based on the current position of the specific user, such that the specific user is able to constantly appear in the image sequence captured by the robot continuously. As the current position of the specific user is tracked, a gesture feature of the specific user is simultaneously extracted by analyzing the image sequence, and an operating instruction corresponding to the gesture feature is recognized through processing the gesture feature by a second classifier, and then the robot is controlled to execute a relevant action according to the operating instruction.

According to an embodiment of the invention, the steps of processing the face regions to locate the current position of the specific user by the first classifier includes detecting the face regions in each image of the image sequence by the first classifier and recognizing each of the face regions to authenticate the identity of a corresponding user. A specific face region with corresponding user identity that is consistent with the specific user is extracted from all of the face regions, and the current position of the specific user is indicated based on the positions of the specific face region in the images containing said specific face region.

According to an embodiment of the invention, the first classifier is a hierarchical classifier constructed based on the Haar-like features of individual training samples, and the step of detecting the face regions in each image of the image sequence includes dividing each image into a plurality of blocks based on an image pyramid rule. Each of the blocks is detected by a detection window to extract a plurality of block features of each of the blocks. The block features of each of the blocks are processed by the hierarchical classifier to detect the face regions from the blocks.

According to an embodiment of the invention, each of the training samples is corresponding to a sample feature parameter that is calculated based on the Haar-like features of the individual training samples. The step of recognizing each of the face regions to authenticate the corresponding user identity includes extracting the Haar-like features of each of the face regions to calculate a region feature parameter corresponding to each of the face regions, respectively. A Euclidean distance between the region feature parameter and the sample feature parameter of each of the training samples is calculated, so as to recognize each of the face regions and authenticate the corresponding user identity based on the Euclidean distance.

According to an embodiment of the invention, the step of tracking the change of the current position of the specific user includes defining a plurality of sampling points adjacent to the current position, respectively calculating the probability that the specific user moving from the current position to each of the sampling points, and acquiring the sampling points with the highest probability as a local current position. A plurality of second-stage sampling points are defined, and the distance between each of the second-stage sampling points and the local current position does not exceed a predetermined value. A probability that the specific user moving from the current position to each of the second-stage sampling points is calculated, respectively. If one of the probabilities corresponding to the second-stage sampling points is greater than the probability corresponding to the local current position, the second-stage sampling point with said probability is determined as the local current position. Another batch of second-stage sampling points is then defined, and the steps for calculating probability and determining the local current position is repeated until the probability corresponding to the local current position is greater than the individual probability for each second-stage sampling points. At this time, the specific user is determined as moving to the local current position, and said local current position is determined as a latest current position. In this method, the above steps are repeated so as to constantly track the changes of the current position for the specific user.

According to an embodiment of the invention, before the step of analyzing the image sequence to extract the gesture feature of the specific user, the method further includes detecting a plurality of skin tone regions in addition to the face regions.

A plurality of local maximum circles exactly covering the skin tone regions are determined, respectively, and one of the skin tone regions is determined as a hand region based on a dimension of each local maximum circles corresponding to the skin tone regions.

According to an embodiment of the invention, the step of analyzing the image sequence to extract the gesture feature of the specific user includes calculating and determining a moving distance and a moving angle of the hand region in the images as the gesture feature based on a position of the hand region in each images of the image sequence.

According to an embodiment of the invention, the second classifier is a hidden Markov model (HMM) classifier constructed based on a plurality of training track samples.

In the invention, a robot including an image extraction apparatus, a marching apparatus, and a processing module is further provided. The processing module is coupled to the image extraction apparatus and the marching apparatus. The processing module processes a plurality of face regions within an image sequence captured by the image extraction apparatus through a first classifier, so as to locate a current position of a specific user according to the face regions. The processing module tracks changes in the current position of the specific user, and controls the marching apparatus to move the robot based on the current position of the specific user so as to ensure that the specific user constantly appears in the image sequence continuously captured by the image extraction apparatus. In addition, the processing module analyzes the image sequence to extract a gesture feature of the specific user and processes the gesture feature through a second classifier to recognize an operating instruction corresponding to the gesture feature and controls the robot to execute an action according to the operating instruction.

According to an embodiment of the invention, the processing module detects the face regions in each image of the image sequence through the first classifier and recognizes each of the face regions to authenticate a corresponding user identity. Among all of the face regions, a specific face region with the corresponding user identity that is consistent with the specific user is extracted, and the current position of the specific user is indicated based on the positions of the specific face region in the corresponding image.

According to an embodiment of the invention, the first classifier is a hierarchical classifier constructed based on Haar-like features of individual training samples. The processing module divides each image into a plurality of blocks based on an image pyramid rule; detects each of the blocks through a detection window to extract a plurality of block features of each of the blocks; and processes the block features of each of the blocks through the first classifier to detect the face regions from the blocks.

According to an embodiment of the invention, each of the training samples is corresponding to a sample feature parameter calculated based on the Haar-like features of the individual training samples. The processing module extracts the Haar-like features of each face regions to calculate a region feature parameter corresponding to each of the face regions, respectively. A Euclidean distance between the region feature parameter and the sample feature parameter of eachtraining samples is calculated by the processing module, so as to recognize each of the face regions and authenticate the corresponding user identity based on the Euclidean distance.

According to an embodiment of the invention, the processing module defines a plurality of sampling points adjacent to the current position, respectively calculates the probability that the specific user moving from the current position to each sampling points, and acquires a sampling points with the highest probability as a local current position. Other second-stage sampling points is then defined, and the steps for calculating probability the local current position is repeated until the probability corresponding to the local current position is greater than the individual probability for each second-stage sampling points. It is determined that the specific user is move to the local current position, and said local current position is determined as a latest current position. The processing module repeats the above operations to constantly track the change of the current position of the specific user.

According to an embodiment of the invention, the processing module detects a plurality of skin tone regions in addition to the face regions; respectively determines a plurality of local maximum circles exactly covering the skin tone regions; and determines one of the skin tone regions as a hand region based on the dimension of each local maximum circles corresponding to the skin tone regions.

According to an embodiment of the invention, the processing module calculates a moving distance and a moving angle of the hand region in different images, so as to determine the gesture feature.

According to an embodiment of the invention, the second classifier is an HMM classifier constructed based on a plurality of training track samples.

Based on the above content, after the specific user is identified in this invention, the position of the specific user is tracked, and the gesture feature thereof is recognized, such that the robot is controlled to execute a relevant action accordingly. Thereby, a remote control is no longer needed to operate the robot. Namely, the robot can be controlled directly by body movements, such as gestures and the like, and significantly improve the convenience of man-machine interaction.

It is to be understood that both the foregoing general descriptions and the detailed embodiments above are merely exemplary and are, together with the accompanying drawings, intended to provide further explanation of technical features and advantages of the invention.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block view illustrating a robot according to an embodiment of the invention.

FIG. 2 is a flowchart illustrating a method for recognizing human faces and gestures according to an embodiment of the invention.

FIG. 3 is a flowchart of tracking changes of a current position of a specific user according to an embodiment of the invention.

### DESCRIPTION OF EMBODIMENTS

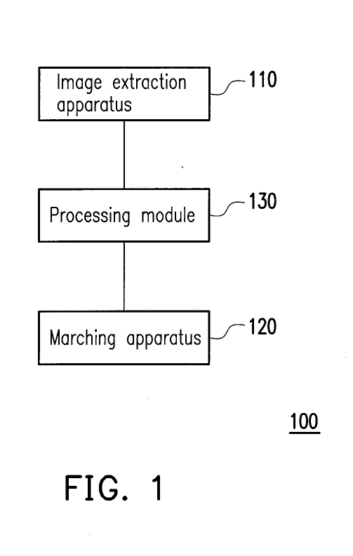

FIG. 1 is a block view illustrating a robot according to an embodiment of the invention. In FIG. 1, the robot 100 includes an image extraction apparatus 110, a marching apparatus 120, and a processing module 130. According to this embodiment, the robot 100 can identify and track a specific user, and can react in response to the gestures of the specific user immediately.

Here, the image extraction apparatus 110 is, for example, a pan-tilt-zoon (PTZ) camera. When the robot 100 is powered up, the image extraction apparatus 110 can continuously extract images. For instance, the image extraction apparatus 110 is coupled to the processing module 130 through a universal serial bus (USB) interface.

The marching apparatus 120 has a motor controller, a motor driver, and a roller coupled each other, for example. The marching apparatus 120 can also be coupled to the processing module 130 through an RS232 interface. In this embodiment, the marching apparatus 120 moves the robot 100 based on instructions of the processing module 130.

The processing module 130 is, for example, hardware capable of data computation and processing (e.g. a chip set, a processor, and so on), software, or a combination of hardware and software. The image sequence captured by the image extraction apparatus 110 is analyzed by the processing module 130, and the robot 100 can be controlled by recognizing and tracking the face and gesture features of the specific user, so as to interact with the specific user (e.g. the owner of the robot 100).

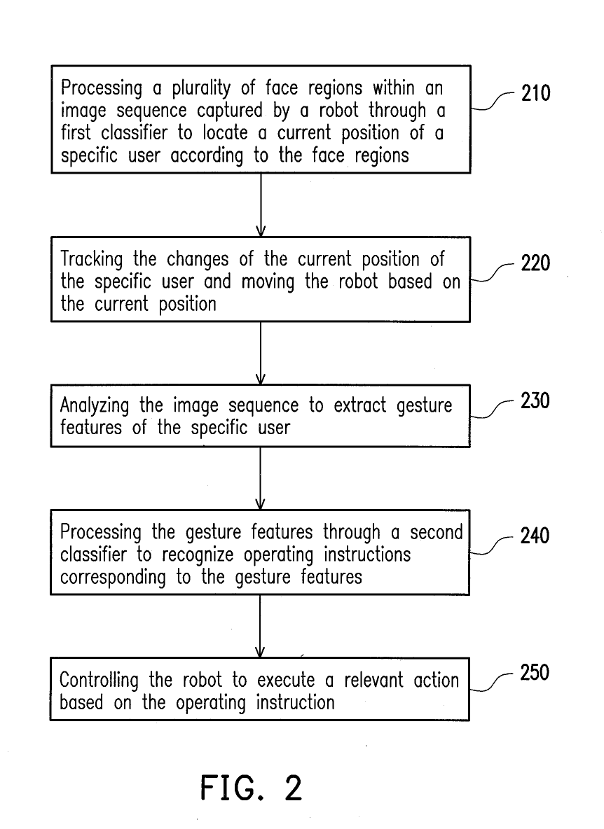

To elucidate the operation of the robot 100 in more detail, another embodiment is provided below. FIG. 2 is a flowchart illustrating a method for recognizing human faces and gestures according to an embodiment of the invention. Please refer to FIG. 1 and FIG. 2. To interact with the specific user, the robot 100 must identify the specific user and track the current position thereof

As indicated in step 210, the processing module 130 processes a plurality of face regions within the image sequence captured by the image extraction apparatus 110 through a first classifier, so as to locate the current position of the specific user according to the face regions.

Particularly, the processing module 130 detects the face regions in each image of the image sequence through the first classifier. In this embodiment, the first classifier is a hierarchical classifier constructed based on a plurality of Haar-like features of individual training samples. More specifically, after the Haar-like features of the individual training samples are extracted, an adaptive boosting (AdaBoost) classification technique is applied to form a plurality of weak classifiers based on the Haar-like features and the concept of image integration. The first classifier is constructed with the hierarchical structure accordingly. Since the first classifier having the hierarchical structure can rapidly filter out unnecessary features, classification processing can be accelerated. During detection of the face regions, the processing module 130 cuts each image into a plurality of blocks based on an image pyramid rule, and each of the blocks is detected by a detection window with a fixed dimension. After several block features (e.g. the Haar-like features) are extracted, the block features of each of the blocks can be classified and processed by the first classifier, so as to detect the face regions from the blocks.

The processing module 130 recognizes each of the face regions to authenticate a corresponding user identity. In this embodiment, a plurality of vectors can be assembled based on the Haar-like features of each of the training samples, so as to establish a face feature parameter model and obtain a sample feature parameter corresponding to each of the training samples. When the face recognition is implemented, the processing module 130 extracts the Haar-like features of each of the face regions to calculate a region feature parameter corresponding to each of the face regions, respectively. The region feature parameter corresponding to each of the face regions are compared to the sample feature parameter of each of the training samples, and a Euclidean distance between the region feature parameter and the sample feature parameter of each of the training samples is calculated, so as to recognize similarity between the face regions and the training samples. Thereby, the user identity corresponding to the face regions can be identified based on the Euclidean distance. For instance, as the Euclidean distance is shorter, the similarity between the face regions and the training samples is greater. Hence, the processing module 130 would determine that the user identity corresponding to the face regions is the training sample with the shortest Euclidean distance between the region feature parameter and the sample feature parameter. Furthermore, the processing module 130 authenticates the user identity according to several images (e.g. ten images) continuously captured by the image extraction apparatus 110, and determines the most possible user identity based on a majority voting principle. Among all the face regions, the face regions that conform with the specific user that corresponds with the user identity are extracted by the processing module 130, and the current position of said specific user is indicated based on the positions of the extracted face regions in each of the images.

Based on the above, the processing module 130 can categorize the face regions in the images into face regions of the specific user and face regions of the non-specific user. In step 220, the processing module 130 regards the specific user as a target to be traced and continuously tracks the changes of the current position of the specific user. Additionally, the processing module 130 controls the marching apparatus 120 to move the robot 100 forward, backward, leftward, or rightward based on the current position of the specific user, so as to keep an appropriate distance between the robot 100 and the specific user. Thereby, it can be ensured that the specific user would constantly appear in the image sequence continuously captured by the image extraction apparatus 110. In this embodiment, the processing module 130 determines the distance between the robot 100 and the current position of the specific user through a laser distance meter (not shown) and controls the marching apparatus 120 to move the robot 100. As such, the specific user would stay within the visual range of the robot 100, and the specific user can appear in the center of the images for the purpose of tracking.

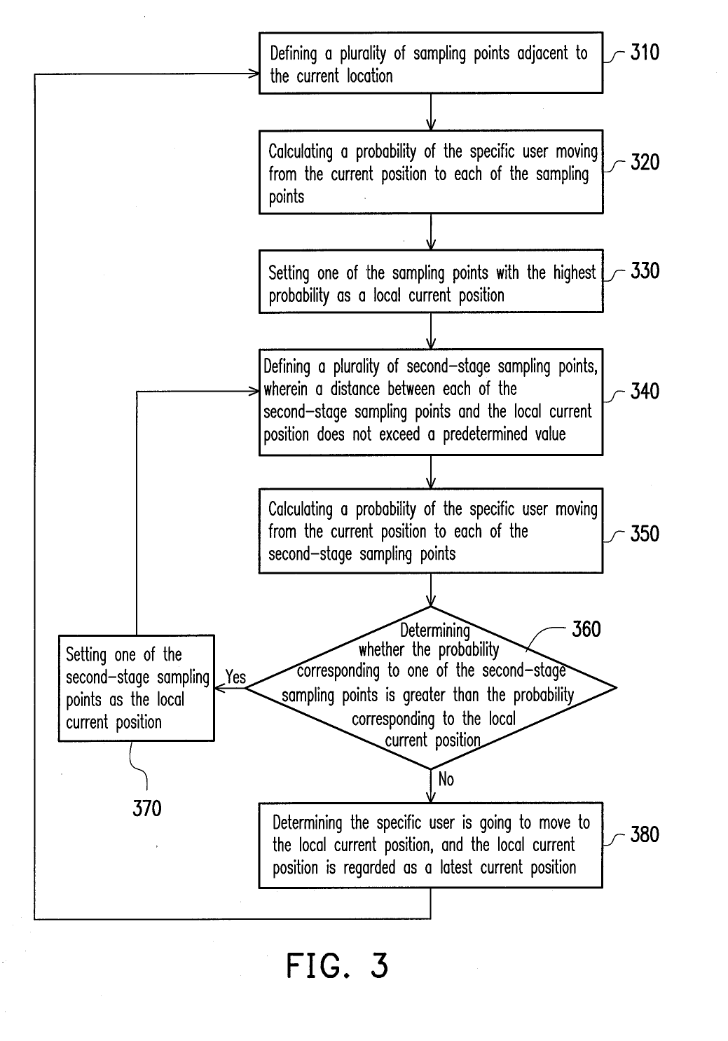

Detailed steps for continuously tracking the change of the current position of the specific user by using the processing module 130 are elaborated hereinafter with reference to FIG. 3. As shown in step 310 in FIG. 3, the processing module 130 defines a plurality of sampling points adjacent to the current position of the specific user in the images. For instance, the processing module 130 can randomly choose 50 pixel positions adjacent to the current position as the sampling points.

In step 320, the processing module 130 calculates the probability of the specific user moving from the current position to each of the sampling points. As indicated in step 330, the sampling points with the highest probability can be served as a local current position.

According to this embodiment, the processing module 130 does not directly determine that the specific user is going to move to the local current position. To obtain the tracking results with better accuracy, the processing module 130 would find out if there is any position with higher probability around the local current position. Hence, in step 340, the processing module 130 defines a plurality of pixel positions that are not more far away from the local current position than a predetermined value as second-stage sampling points, and calculates the probability of the specific user moving from the current position to each of the second-stage sampling points in step 350.

In step 360, the processing module 130 determines if the probability corresponding to one of the second-stage sampling points is greater than the probability corresponding to the local current position. If so, in step 370, the processing module 130 regards one of the second-stage sampling points as the local current position and returns to step 340 to define another batch of second-stage sampling points. Step 350 and step 360 are then repeated.

Nonetheless, if the probability corresponding to the local current position is greater than the probability of each of the second-stage sampling points, the processing module 130 determines that the specific user is going to move to the local current position. The processing module 130 regards the local current position as the latest current position and repeats the steps shown in FIG. 3 to continuously track the changes of the current position of the specific user.

After the processing module 130 starts to track the specific user, the processing module 130 also detects and recognizes hand gestures of the specific user. As indicated in step 230, the processing module 130 analyzes the image sequence to extract gesture features of the specific user.

Specifically, before the gesture features are extracted, the processing module 130 detects a plurality of skin tone regions from the images in addition to the face regions. A hand region of the specific user is further determined by the processing module 130 from the skin tone regions. According to this embodiment, the processing module 130 determines a plurality of local maximum circles that exactly covering the skin tone regions respectively, and one of the skin tone regions is determined as the hand region based on the dimension of each of the local maximum circles corresponding to the skin tone regions. For instance, in the local maximum circles respectively corresponding to the skin tone regions, the processing module 130 regards the circle with the largest area as a global maximum circle, and one of the skin tone regions corresponding to the global maximum circle is the hand region. For instance, the processing module 130 determines the center of the global maximum circle as the center of the palm. As such, no matter whether the specific user wears a long sleeve shirt or a short sleeve shirt, the processing module 130 can filter out the arms and locate the center of the palm. According to another embodiment, the processing module 130 can also use two circles with the largest area to indicate two palms of the specific user on the condition that the specific user uses both hands. In this embodiment, once the processing module 130 detects the hand region to be tracked, the processing module 130 can improve tracking efficiency by conducting a partial tracking, so as to prevent interference resulting from non-hand regions.

When the specific user controls the robot 100 by gesticulating or swinging their hands, different dynamic tracks shown by the palms of the specific user represent within the image sequence extracted by the image extraction apparatus 110. To distinguish various kinds of gesture features of the specific user, the processing module 130 calculates a moving distance and a moving angle of the hand region in the images and regards the moving distance and the moving angle as the gesture feature based on a position of the hand region in each of the images of the image sequence. In particular, through the position of the hand region been recorded, the processing module 130 can observe the track of the hand movement for the specific user and further determine the moving distance and the moving angle.

In step 240, the processing module 130 processes the gesture features through a second classifier, so as to recognize operating instructions corresponding to the gesture features. According to this embodiment, the second classifier is a hidden Markov model (HMM) classifier constructed based on a plurality of training track samples. Each of the training track samples corresponds to a different time of extraction. After the second classifier extracts the gesture features, the second classifier calculates a probability of the training track samples conforming with the gesture features. The processing module 130 then determines the training track samples with the highest probability, and the instruction corresponding to the said training track samples is regarded as an operating instruction corresponding to the gesture feature.

In step 250, the processing module 130 controls the robot 100 to execute a relevant action based on the operating instruction. For instance, the processing module 130 can, according to the gestures of the specific user, control the marching apparatus 120 to move the robot 100 forward, move the robot 100 backward, rotate the robot 100, stop the robot 100, and so on.

In light of the foregoing, according to the method of recognizing faces and gestures of the invention, when the specific user in the images is recognized by the classifier, the specific user is continuously tracked, and the gesture features of the specific user are detected and processed by the classifier so as to control the robot to execute a relevant action. Thereby, it is not necessary for the owner of the robot to use a physical remote control to operate the robot. Namely, the robot can be controlled directly by the body movements of the specific user, such as gestures and the like, and can significantly facilitate man-machine interaction.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for recognizing human faces and gestures that are suitable for recognizing movement of a specific user to operate a robot, the method comprising:
processing a plurality of face regions within an image sequence captured by the robot through a first classifier, so as to locate a current position of the specific user according to the face regions, the image sequence comprising a plurality of images;
tracking the changes of the current position of the specific user and moving the robot based on the current position of the specific user, such that the specific user can be constantly appear in the image sequence continuously captured by the robot;
analyzing the image sequence to extract a gesture feature of the specific user;
processing the gesture feature through a second classifier to recognize an operating instruction corresponding to the gesture feature; and
controlling the robot to execute an action based on the operating instruction.

2. The method as claimed in claim 1, the step of processing the face regions through the first classifier to locate the current position of the specific user comprising:
detecting the face regions in each of the images of the image sequence through the first classifier;
recognizing each of the face regions to authenticate a corresponding user identity;
extracting a specific face region from all of the face regions, wherein the corresponding user identity of the specific face region is consistent with the specific user; and
indicating the current position of the specific user based on the positions of the specific face region in an image containing the specific face region.

3. The method as claimed in claim 2, wherein the first classifier is a hierarchical classifier constructed based on a plurality of Haar-like features of individual training samples, and the step of detecting the face regions in each of the images of the image sequence comprises:
dividing each of the images into a plurality of blocks based on an image pyramid rule;
detecting each of the blocks by a detection window to extract a plurality of block features of each of the blocks; and
processing the block features through the first classifier to detect the face regions from the blocks.

4. The method as claimed in claim 3, wherein each of the training samples is corresponding to a sample feature parameter calculated based on the Haar-like features of the individual training samples, and the step of recognizing each of the face regions to authenticate the corresponding user identity comprises:
extracting the Haar-like features of each of the face regions to calculate a region feature parameter respectively corresponding to each of the face regions; and
calculating a Euclidean distance between the region feature parameter and the sample feature parameter of each of the training samples, so as to recognize each of the face regions and authenticate the corresponding user identity based on the Euclidean distance.

5. The method as claimed in claim 1, the step of tracking the change of the current position of the specific user comprising:
a. defining a plurality of sampling points adjacent to the current position;
b. respectively calculating a probability of the specific user moving from the current position to each of the sampling points;
c. acquiring one of the sampling points with a highest probability as a local current position;
d. defining a plurality of second-stage sampling points, wherein a distance between each of the second-stage sampling points and the local current position does not exceed a predetermined value;
e. respectively calculating a probability of the specific user moving from the current position to each of the second-stage sampling points;
f. if the probability corresponding to one of the second-stage sampling points is greater than the probability corresponding to the local current position, setting one of the second-stage sampling points as the local current position and repeating the step d to the step f; and
g. if the probability corresponding to the local current position is greater than the probability of each of the second-stage sampling points, then determining that the specific user is going to move to the local current position, and the local current position is regarded as a latest current position and repeating step a to step g to continuously track the changes of the current position of the specific user.

6. The method as claimed in claim 1, wherein before the step of analyzing the image sequence to extract the gesture feature of the specific user, further comprising:
detecting a plurality of skin tone regions in addition to the face regions;
determining a plurality of local maximum circles exactly covering the skin tone regions, respectively; and
determining one of the skin tone regions as a hand region based on a radius of each of the local maximum circles corresponding to the skin tone regions.

7. The method as claimed in claim 6, the step of analyzing the image sequence to extract the gesture feature of the specific user comprising:
calculating a moving distance and a moving angle of the hand region in the images and determining the moving distance and the moving angle as the gesture feature based on a position of the hand region in each of the images of the image sequence.

8. The method as claimed in claim 1, wherein the second classifier is a hidden Markov model (HMM) classifier constructed based on a plurality of training track samples.

9. A robot comprising:
an image extraction apparatus;
a marching apparatus; and
a processing module coupled to the image extraction apparatus and the marching apparatus,
wherein the processing module processes a plurality of face regions within an image sequence captured by the image extraction apparatus through a first classifier, locates a current position of a specific user from the face regions, tracks changes of the current position of the specific user, and controls the marching apparatus to move the robot based on the current position of the specific user so as to ensure that the specific user constantly appears in the image sequence continuously captured by the image extraction apparatus, the image sequence comprising a plurality of images,
the processing module analyses the image sequence to extract a gesture feature of the specific user and processing the gesture feature through a second classifier to recognize an operating instruction corresponding to the gesture feature, and controls the robot to execute an action according to the operating instruction.

10. The robot as claimed in claim 9, wherein the processing module detects the face regions in each of the images of the image sequence through the first classifier, recognizes each of the face regions to authenticate a corresponding user identity, extracts a specific face region from all of the face regions, in which the corresponding user identity of the specific face region is consistent with the specific user, and indicates the current position of the specific user based on positions of the specific face region in an image containing the specific face region.

11. The robot as claimed in claim 10, wherein the first classifier is a hierarchical classifier constructed based on a plurality of Haar-like features of individual training samples, and the processing module divides each of the images into a plurality of blocks based on an image pyramid rule, detects each of the blocks by a detection window to extract a plurality of block features of each of the blocks, and processes the block features of each of the blocks through the first classifier to detect the face regions from the blocks.

12. The robot as claimed in claim 10, wherein each of the training samples is corresponding to a sample feature parameter calculated based on the Haar-like features of the individual training samples, and the processing module extracts the Haar-like features of the face regions to calculate a region feature parameter corresponding to each of the face regions respectively and calculates a Euclidean distance between the region feature parameter and the sample feature parameter of each of the training samples so as to recognize each of the face regions and authenticate the corresponding user identity based on the Euclidean distance.

13. The robot as claimed in claim 9, the processing module defining a plurality of sampling points adjacent to the current position, respectively calculating a probability of the specific user moving from the current position to each of the sampling points, and acquiring one of the sampling points with a highest probability as a local current position,
the processing module defining a plurality of second-stage sampling points that are not more far away from the local current position than a predetermined value and respectively calculating a probability of the specific user moving from the current position to each of the second-stage sampling points,
if the probability corresponding to one of the second-stage sampling points is greater than the probability corresponding to the local current position, the processing module regards one of the second-stage sampling points as the local current position and repeatedly defines the second-stage sampling points and calculates the probability of the specific user moving from the current position to each of the second-stage sampling points,
if the probability corresponding to the local current position is greater than the robability of each of the second-stage sampling points, the specific user is determined to move to the local current position by the processing module, and the local current position is regarded as a latest current position,
the processing module repeating above procedure to continuously track the change of the current position of the specific user.

14. The robot as claimed in claim 9, wherein the processing module detects a plurality of skin tone regions in addition to the face regions, respectively determines a plurality of local maximum circles exactly covering each of the skin tone regions, and determines one of the skin tone regions as a hand region based on a radius of each of the local maximum circles corresponding to the skin tone regions.

15. The robot as claimed in claim 14, wherein the processing module calculates a moving distance and a moving angle of the hand region in the images and regards the moving distance and the moving angle as the gesture feature based on a position of the hand region in each of the images of the image sequence.

16. The robot as claimed in claim 9, wherein the second classifier is a hidden Markov model classifier constructed based on a plurality of training track samples.
